(19) United States
(12) Patent Application Publication
(10) Pub. No.: US 2012/0268448 A1
(43) Pub. Date: Oct. 25, 2012

(54) CONNECTION DIAGNOSTIC DEVICE AND CONNECTION DIAGNOSTIC METHOD FOR A DISPLAY

(76) Inventors: Herve Wicky, Turckheim (FR); David Tihay, Eschau (FR)

(21) Appl. No.: 13/515,926

(22) PCT Filed: Dec. 26, 2010
(86) PCT No.: PCT/EP2010/068325

§ 371 Date: Jul. 12, 2012

(30) Foreign Application Priority Data
Dec. 16, 2009 (FR) 0959028

(51) Int. Cl. G09G 3/36; G06F 3/038

(52) U.S. Cl. 345/212; 345/87

(57) ABSTRACT

An electronic device comprising a liquid crystal display and a control board, the electrical tracks of the board and of the display being connected by a connector, the control board including a microcontroller able to apply an electrical voltage to at least one connection terminal in order to display given information on the display, characterised by the fact that the control board includes a diagnostic device which is designed to generate a voltage pulse at connection terminals and to measure the resulting electrical voltage in order to determine the state of the connection between the display and the board as a function of the value of the measured electrical voltage.

### CROSS-REFERENCE TO RELATED APPLICATION

This application claims the benefit under 35 U.S.C. §371 of published PCT Patent Application No. PCT/EP 2010/068325, filed Nov. 26, 2010, and was published as WO2011/073014A1 on Jun. 23, 2011, the entire contents of which is hereby incorporated by reference herein.

### TECHNICAL FIELD OF INVENTION

The present invention relates to an electronic device provided with a liquid crystal display in particular intended to be installed on a structural element of a motor vehicle. The present invention also relates to a diagnostic method of the state of connection of the display.

### BACKGROUND OF INVENTION

In the motor vehicle field, it is usual to provide a vehicle with an electronic device including two electronic components connected to each other by a flexible connector. Such a device is, for example, an information display device which is intended to be installed on a structural element of the vehicle, such as a dashboard, a console, or the like. This device is, for example, designed to deliver information to a user of the vehicle, such as general information, of the type of date, time, temperature outside the vehicle, or the like. This device is also able to deliver to the user particular information relating to the functioning of the vehicle, or even information relating to the functioning of apparatus fitted to the latter, such as ventilation, heating and/or air-conditioning apparatus.

When the electronic device is a display device, it generally includes a first electronic component that consists of a liquid crystal display and a second electronic component that consists of a control board for operation of the display. The control board and the display are housed in a case being arranged for example superimposed one on the other. A light source, such as an electroluminescent diode or the like, is placed between the display and the control board to illuminate the display by back-lighting.

The display includes a plurality of electrical tracks that comprise display segments incorporated in the display. Each segment is formed of liquid crystals, for example from a photolithography process, and is controlled by two electrodes. An electrical voltage is able to be applied to the electrodes of a segment to orientate the liquid crystals of the latter so that the light emitted by the light source passes through it. The application of the electrical voltage to a particular segment is controlled by a microprocessor mounted on the control board or by another electronic component such as a liquid crystal display driver. Of course the display can also include pixels instead of the segments.

To electrically connect the electrical tracks forming the electrodes of the display to the electrical tracks connected to the microprocessor of the control board it is necessary to arrange an electrical connector between the two components.

In this type of application, the connector used is generally a flexible connector of the ZEBRA® type that includes a plurality of conductive strips made of carbon separated by insulating strips made of an electrically insulating polymer such as a silicone or the like. The flexible connector is mounted slightly compressed between the control board and the display so that the conductive strips are in electrical contact on one side with the connection terminals of the control board and on the other with connection terminals of the display.

On assembly of the electronic device, it happens that the flexible connector is badly mounted so that certain connection terminals of the display are not electrically connected to the control board which causes malfunction of the display. It also happens that the connector and/or the display are overlooked during mounting which prevents any functioning of the electronic device. This type of mounting error occurs more easily as these mounting operations are generally performed by hand.

It is known to use in the assembly line visual detection systems requiring cameras in order to detect the presence of components and/or positioning errors. However, these detection systems are particularly expensive to implement and they do not allow detection of all mounting errors. Moreover, these systems do not permit detection of mounting errors after location of the electronic device in the complete equipment, for example in the control panel of a ventilation and heating system.

For example, in certain cases, the display is not mounted on the control board but it is mounted right at the end of assembly, when the control knob, equipped with the display, is positioned on the dashboard of the vehicle that carries the control board. In this case, the diagnostic of the mounting of the electronic device can only be performed at the end of assembly that in particular excludes the use of detection cameras.

### SUMMARY OF THE INVENTION

To resolve the problems mentioned above, the invention proposes an electronic device comprising a liquid crystal display and a control board for operating the display, the electrical tracks of the board being electrically connected to the electrical tracks of the display by means of a connector which is in contact on one side with a first series of connection terminals carried by the board and on the other with a second series of connection terminals carried by the display, the control board including an electronic control unit able to apply an electrical voltage to at least one connection terminal of the first series in order to display given information on the display, characterized by the fact that the control board includes a diagnostic device which is designed to generate a voltage pulse at the connection terminals of the first series and to measure the resulting electrical voltage in order to determine the state of the connection between the display and the board as a function of the value of the electrical voltage measured.

Diagnostic of the state of the connection here means the determination of an operational electrical connection between the control board and the display consecutive to a correct positioning of the connector relative to the board and to the display. This diagnostic method also permits detection of the absence of the display and/or of the connector.

An advantage of the present invention is that it requires no modification to the connector, to the control board, or to the display and that it does not require a complex external control device. Moreover, the present invention can be implemented at any moment after assembly of the display on the control board.

In accordance with other advantageous characteristics of the invention: the diagnostic device comprises an electronic control unit which is arranged on the control board; the electronic control unit is formed by the microcontroller that controls the display; the connector is a flexible connector; the flexible connector comprises an alternated succession of electrically conductive strips and electrically insulating strips, orientated parallel with the lateral edges of the flexible connector so that the ends of a conductive strip and the ends of an insulating strip are arranged in alternation along the longitudinal edges of the flexible connector; the electrically insulating strips are made of a flexible plastics material, in particular silicone.

The invention also proposes interior equipment of a motor vehicle including at least a control knob designed to control an operating parameter of the equipment, characterized by the fact that an electronic device in accordance with one of the preceding characteristics is arranged in the control knob so that the display displays information linked to the operating parameter of the equipment. This equipment forms part for example of a ventilation, heating and/or air-conditioning system.

The invention also proposes a diagnostic method for an electronic device in accordance with one of the preceding characteristics, the said method being intended to determine the state of connection of the display to the control board. It is characterized by the fact that it includes the following steps: generation of a voltage pulse at at least one connection terminal of the first series, measurement of the electrical voltage at one or more connection terminals associated with the first series, comparison of the measured voltage with a threshold value, emission of a diagnostic signal representative of the state of the connection, the said diagnostic signal being positive when the measured voltage is greater than the threshold value and negative when the measured voltage is lower than the threshold value.

The method is preferably implemented by means of an electronic control unit which is arranged on the control board. The electronic control unit is formed by the microcontroller that controls the display.

Further features and advantages will appear more clearly on a reading of the following detailed description of the preferred embodiment, which is given by way of non-limiting example only and with reference to the accompanying drawings.

### BRIEF DESCRIPTION OF DRAWINGS

Other characteristics, aims and advantages of the invention will become apparent on reading the following detailed description, with reference to the attached drawings, given by way of non-limiting example and in which:

FIG. 1 is an exploded perspective view that shows diagrammatically a control panel fitted with a display device formed in accordance with the teachings of the invention;

FIG. 2 is a diagram that shows the electrical connection between the control board and the display of the display device of FIG. 1;

FIG. 3 is a diagram that shows the electrical supply circuit of a segment of the display of FIG. 2;

FIG. 4 is a diagram that shows the supply voltage as a function of time and that shows a voltage pulse used to diagnose the state of the connection of the display device of FIG. 1;

FIGS. 5 and 6 are diagrams similar to that of FIG. 4 that show in parallel the voltage pulse and the resulting voltage measured by the microcontroller fitted to the display device of FIG. 1.

### DETAILED DESCRIPTION

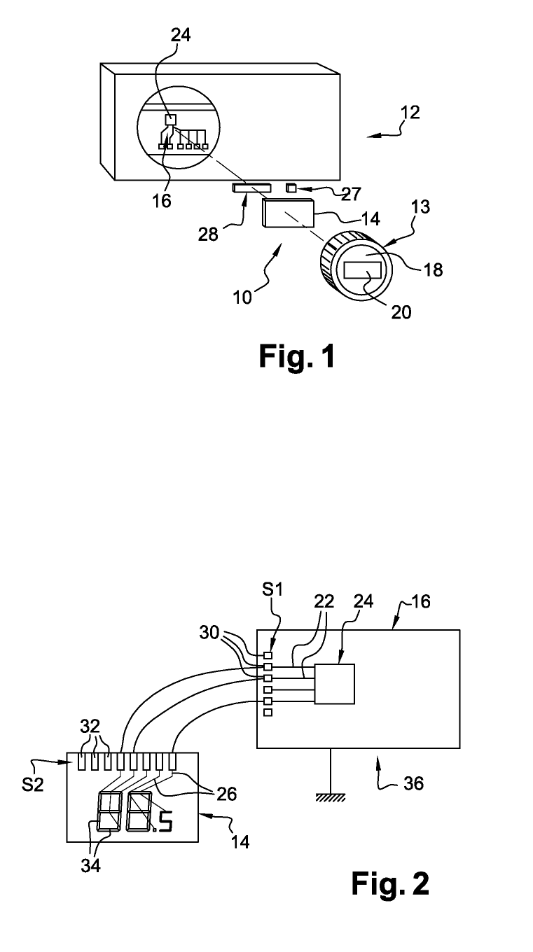

FIG. 1 shows an electronic device 10 in accordance with a preferred embodiment of the invention. In accordance with this embodiment, the electronic device 10 is a display device which is arranged in interior equipment of the motor vehicle 12, in particular in a control panel 12 belonging to a ventilation, heating and/or air-conditioning apparatus. More particularly, the display device 10 is associated with a rotary control knob 13 for controlling an operating parameter of the apparatus such as the interior temperature of the vehicle.

The display device 10 includes a liquid crystal display 14 and a control board 16 for operating the display 14. In accordance with the embodiment shown, the display 14 is mounted inside a fixed part 18 of the rotary control knob to be visible to a user through a suitable window 20.

The control board 16 is here mounted on a fixed support within the control panel 12. It includes electrical tracks 22 shown diagrammatically in FIG. 2, which are designed to electrically connect a microcontroller 24 carried by the board 16 to the electrical tracks 26 of the display 14. The board 16 generally includes a light source such as an electroluminescent diode 27 designed to backlight the display 14.

The electrical connection between the control board 16 and the display 14 is effected by means of a connector 28 which is in contact on one side with a first series S1 of connection terminals 30 carried by the board 16 and on the other with a second series S2 of connection terminals 32 carried by the display 14. The microcontroller 24 is designed to apply a determined electrical voltage to at least one connection terminal 30 of the first series Si in order to display given information on the display 14.

The connector 28 is preferably a flexible connector. Here “flexible connector” means a connector 28 that can be compressed in the direction of the connection without suffering deterioration. Such a connector 28 is known as a leaved elastomeric connector (called “ZEBRA® connector”) including an alternated succession of electrically conductive strips, for example made of carbon, and of electrically insulating strips, for example made of a plastics material such as silicone. This succession of strips orientated parallel with the lateral edges of the connector 28 forms on the longitudinal ends of the connector 28 two opposed connection surfaces which are designed to cooperate with the two series S1, S2 of connection terminals 30, 32 respectively.

When the elements forming the display device 10 are assembled, the flexible connector 28 is interposed between the display 14 and the control board 16, so that the longitudinal edges of the flexible connector 28 are kept in contact, and finally compressed, against the connection terminals 30 of the control board 16 and the connection terminals 32 of the display 14 respectively.

The display 14 incorporates a plurality of electrical tracks 26 each including at least one display segment 34 formed of liquid crystals. Each electrical track 26 comprises a connection terminal 32 arranged at the peripheral edge of the display 14. Each connection terminal 32 of the display 14 is in contact with a first end of a conductive strip of the flexible connector 28, the second end of each conductive strip being in contact with an associated connection terminal 30 on the control board 16.

The microcontroller 24 is able to deliver a voltage to electrodes bordering each display segments 34 to so orientate the liquid crystals of the latter that they allow passage of the light emitted by the light source 27. This voltage is transmitted from the microcontroller 24 to a particular display segment 34 via the corresponding connection terminal 30 of the control board 16, then the conductive strip allocated to this connection terminal 30, and then the corresponding connection terminal 32 of the display 14 which is in contact with the electrical track 26 including the said particular segment 34.

To actuate the lighting of a segment 34, the microcontroller 24 applies a determined control voltage between a first connection terminal 30 of the board 16 corresponding to a common signal COM and a second connection terminal 30 corresponding to a segment signal SEG.

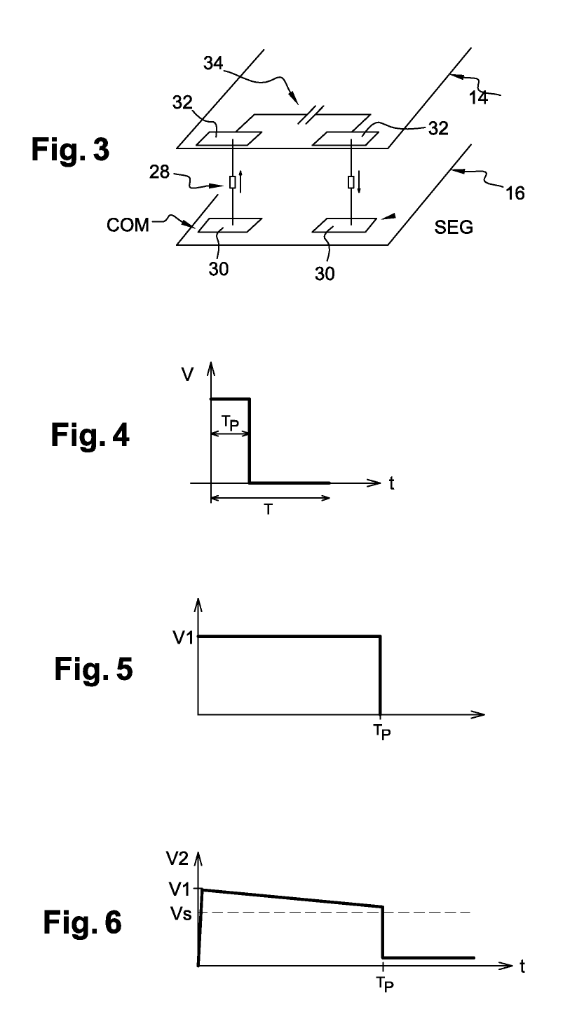

As shown by the diagram of FIG. 3, the electrical supply circuit controlling a display segment 34 of the display 14 corresponds to a capacitive circuit, the behavior of a segment 34 being electrically equivalent to a capacitor. The conductive strips of the connector 28 are electrically equivalent to resistances.

In accordance with the teachings of the invention, the control board 16 includes a diagnostic device 36 which is designed to generate a voltage pulse V1 at each connection terminal 30 of the first series S1 corresponding to a common signal COM and to measure the resulting electrical voltage V2 at each associated connection terminal 30 of the first series S1 corresponding to the segment signal SEG.

FIG. 4 shows such a voltage pulse V1 applied to a connection terminal 30 for a determined duration Tp over a time period T. The voltage V1 is the output voltage of the control board 16 with on/off output.

FIGS. 5 and 6 show an example pulse V1 during a determined duration Tp and the voltage V2 measured by the microcontroller during this duration Tp. It is found that the measured voltage V2 is substantially equal to the applied voltage V1, despite a slight loss of voltage over time. The measured voltage V2 remains above a threshold value Vs, which indicates a sufficient quality of the connection between the connection terminals 30 of the first series S1 and the connection terminals 32 of the second series S2, for the diagnosed segment 34.

The threshold voltage Vs is here equal to the reading threshold of the control board 16 in on/off mode. This reading takes place a few microseconds after the voltage pulse V1 is sent.

The same pulse V1 is applied to each connection terminal 30 of the first series S1 corresponding to a common signal COM so that the whole of the connection effected by the connector 28 can be tested and diagnosed. If at least one measured voltage V2 is lower than the threshold voltage Vs, the diagnostic device 36 deduces from this a connection problem at the connector 28. Such a problem is generally due to bad positioning of the connector 28. If all the measured voltages V2 are lower than the threshold voltage Vs, it is possible that the connector 28 or the display 14 has been completely omitted during assembly of the display device 10, which will be detected by the diagnostic device 36.

The diagnostic of the display device 10 described above is preferably performed in accordance with the following diagnostic method.

After mounting of the display 14 in the control knob 13, the control knob 13 is mounted on the control panel 12 so that the display 14 is connected to the control board 16 by means of the flexible connector 28 or of another type of connector.

The microcontroller 24 then generates a voltage pulse V1 at at least one connection terminal 30 of the first series S1, preferably at all the connection terminals 30 corresponding to the common signals COM. The resulting electrical voltage V2 at the corresponding connection terminals 30 of the first series S1, here the connection terminals 30 corresponding to the segment signals SEG, is measured by the microcontroller 24.

The microcontroller 24 compares the measured voltages V2 with the threshold value Vs. Depending on the result of the comparison, the microcontroller 24 produces positive or negative diagnostic information giving an indication as to the state of the connection between the control board 16 and the display 14.

When at least one measured voltage V2 is lower than the threshold value Vs, the microcontroller 24 emits a negative diagnostic signal which can be read by a control apparatus (not shown).

Advantageously, the diagnostic method is implemented at the initialization phase of the display device 10, just after its assembly on the control panel 12. It can also be implemented periodically by the microcontroller 24 and/or on demand, for example during a diagnostic phase of the electrical equipment of the vehicle fitted with the control panel 12.

In accordance with a modified embodiment, the diagnostic can be performed by application of a plurality of successive voltage pulses.

In accordance with another modified embodiment, a diagnostic strategy can be implemented, for example adapting the frequency or the value of the voltage pulses, so as to allow more precise detection of the origin of a possible connection fault.

While this invention has been described in terms of the preferred embodiments thereof, it is not intended to be so limited, but rather only to the extent set forth in the claims that follow.

1. An electronic device comprising a liquid crystal display, a flexible connector, and a control board for operating the display, wherein electrical tracks of the board are electrically connected to electrical tracks of the display by the flexible connector in contact with a first series (S1) of connection terminals (30) carried by the board (16) and a second series of connection terminals carried by the display, the control board including an electronic control unit able to apply an electrical voltage to at least one connection terminal of the first series in order to display given information on the display, wherein
the control board includes a diagnostic device configured to generate a voltage pulse at the first series, and to measure the resulting electrical voltage in order to determine a state of connection between the display and the board based on a value of the measured electrical voltage.

2. The electronic device of claim 1, wherein the diagnostic device (36) comprises an electronic control unit (24) arranged on the control board (16).

3. The electronic device of claim 2, wherein the electronic control unit (24) is formed by the microcontroller that controls the display (14).

4. The electronic device of claim 1, wherein the flexible connector comprises an alternated succession of electrically conductive strips and electrically insulating strips, said strips orientated parallel with lateral edges of the flexible connector so that ends of a conductive strip and ends of an insulating strip are arranged in alternation along longitudinal edges of the flexible connector.

5. The electronic device of claim 1, wherein the electrically insulating strips are made of a flexible plastics material.

6. Interior equipment of a motor vehicle including at least a control knob designed to control an operating parameter of the equipment, characterised by the fact that an electronic device as described in claim 1 is arranged in the control knob so that the display displays information linked to the operating parameter of the equipment.

7. The interior equipment of claim 6, wherein the interior equipment is part of a ventilation, heating and/or air-conditioning apparatus.

8. A diagnostic method for an electronic device configured to determine a state of connection between a first series of connection terminals carried by the board and a second series of connection terminals carried by the display, said method comprising:
generating a voltage pulse at at least one connection terminal of the first series corresponding to a common signal,
measuring, in response to the voltage pulse, an electrical voltage at one or more associated connection terminals of the first series corresponding to a segment signal,
comparing the electrical voltage with a threshold value, emitting a diagnostic signal indicative of the state of the connection.

9. (canceled)

10. The method of claim 8, wherein the diagnostic signal is characterized as positive when the electrical voltage is greater than the threshold value, and negative when the electrical voltage is less than the threshold value.
